(19) United States
(12) Patent Application Publication
(10) Pub. No.: US 2008/0279989 A1
(43) Pub. Date: Nov. 13, 2008

(54) Method and apparatus for enhancing tasting experiences

(76) Inventors: Lance D. Ruttledge, Kenwood, CA (US); Lawrence A. Bennett, Benicia, CA (US)

Correspondence Address: Lawrence A. Bennett, 111 Riverview Terrace, Benicia, CA, 94510, US

(21) Appl. No.: 11/800,869

(22) Filed: May 7, 2007

(51) Int. Cl. A23L 1/221

(52) U.S. Cl. 426/90; 426/104; 426/108; 426/132; 426/534; 426/89

(57) ABSTRACT

A method and apparatus to be employed in tasting processes for the purpose of characterizing the aromatic qualities of, for example, a wine, single malt scotch, hot brewed coffee or tea, chocolate, breads, food oils or similar type of aromatic product. The apparatus comprises a carrier material suitable for the support of aromatic scents of a variety found in wines, other beverages and other foods. The apparatus provides for the grouping of scents according to, for example, commonly found groupings of flavors in wine, distilled, brewed, hot brewed, food oils, chocolate or other aromatic food products. The apparatus provides for ease of separation of the individual scents or groups appropriate to the users current experience. The apparatus includes carrier material to which the aromatic scents are applied or to which the scents have been previously applied. The method of tasting using the aromatic scents comprises the use of one or more cards or subsets of the cards carrying the aromatic scents in a manner that results in a single scent or a grouping of scents appropriate to the beverage being consumed in a tasting. The vendors of many beverages have characterized the aroma of the product and one goal of the method is to enable the taster to discern the aromas of the beverage as part of his or her tasting experience.

### BACKGROUND OF THE INVENTION

1. Field of the Invention

The present invention relates generally to the methods and apparatus for tasting beverages, oils and other foods.

2. Description of the Related Art

The evolution in wine tasting and appreciation has been driven by a concerted marketing effort on the part of wine making companies, supporting tourism businesses and a growing understanding of the average consumer of wine types, growing regions and pairings with food for enhanced dining experiences. Webster's defines oenophile as a lover or connoisseur of wine. A category of consumers have come to not only know the definition of the term, but consider themselves oenophiles.

Wineries and wine marketing organizations promote wine use the aromatic qualities to characterize the experience and to assist tasters in the selection of wine. The characteristics of the wine are used for comparison to other wines, wine regions and for food pairings. As part of the tasting of the wine, the taster is left with these directions and his or her own nose to discern the aromas and flavors that may be present in the wine or other beverage. It is one objective of the present invention to provide an apparatus and method to assist the taster who tastes wine or other aromatic beverages by providing comparison aromatic scents.

Additionally, single malt scotch brands have specific scents and aromas called out on their labels as an enhancement to the taster seeking to discern what they are consuming, what they like about it and to give the consumer some talk about the beverage to complete the experience and share the common experience with others. This enhanced experience requires some suggestion to the taster to enable him or her to discern what is present in the beverage being sampled.

The emergence of coffee and tea shops on every corner of America, have made consumers aware of a great many different flavor and aroma experiences. He is now confronted with a dizzying array of choices for morning and, now evening, coffees just when he is trying to get to work or home. In this promotion, it has become more and more difficult to sample and make the choices necessary for a well thought out choice of beverage.

Additionally, it is well known in the art, that the taste of a consumed item is heavily influenced by the aroma or “nose” of the thing being tasted or sampled. In the case of wine and other fermented or distilled beverages, the vendor provides the user with a written description of the flavors that are asserted present in the item being consumed by the user. In this suggestive manner, the vendor is attempting to create an experience in the use of the product, and thereby differentiate the product from others and attempt to make the taster feel as though the use of the product is an experience rather than a simple exercise of consumption.

Prior art attempts to address this issue have, in at least one case, been to create guidance to wine enthusiasts to better describe the aromas encountered in the experience of tasting wine. The intent is to prompt the person's memory with words that describe the aromas, such as apple, nutty, or fig, to name a few. An example of this approach can be found at http://www.essentialwinetastingguide.com/. The guide provides a pocket reference of the aromas encountered in the different wine varietals. This type of art represents the compilation of notes made over years of tasting and shared with wine connoisseurs and consumers. The intent of this type of guidance is to enhance their mental relationship to aromas they may have sampled in the past.

This discernment of the tastes present in the beverage or palate of the beverage is all part of a tasting experience that involves the examination of the product in a glass or other vessel suitable for viewing the color, sediment that may be present, checking other qualities such as the weight or body of the beverage, sampling the nose of the beverage, as is the subject of the present invention, examining the palate of the beverage, and evaluating the finish of the sample taken as part of the method of tasting the beverage. It is this overall experience that the present invention intends to enhance with a method and apparatus not present in prior art attempts to enhance the tasting experience.

Additional art attempts to provide an extensive selection of aromas claim they will allow an amateur taster to gain the palate of an expert. An example of such an aroma collection is the Le Nez Du Vin Wine Education Kit, which can be found at www.shop.com as of January 2007. The product description says it is a kit that will enable the user to develop his senses to the level of experts and allow the detection of wine components and the environment in which it was grown.

Much as wine tasters have created a wine tasting wheel to use an agreed upon terminology, coffee tasters can use the a Coffee Taster's Flavor Wheel to grade coffees or a flavor characteristics chart. The flavor wheel is designed for the trained pallet of a professional. Professionals can use the guidance when buying coffee and for creating taste characteristic profiles of the coffees. The average consumer who may not appreciated all that the professional is promoting in the coffee can use a much simplified flavor characteristics chart, which is a simplified method of charting your favorite coffee or brewed beverage characteristics. Similar embodiments of flavor guidance exists for aromatic oils, such as olive oils, and any other aromatic fine food that has a “family” of aromas and flavors dependent upon the type of stock or material, or processing used to make it.

What the prior art lacks is a method or apparatus that presents the aromas or essences in an environment or method that is similar to that which the wine or other beverage will be tasted and simulates that experience in a manner of elegance similar to the actual tasting itself. The prior art merely presents the essences in some sort of container and provides instructions as to which wines would be expected to have particular scents. There is no enhancing of the wine tasting experience occurring when the user of these types of products has to lug around a kit of vials or other form of essence container.

Therefore, what is needed is a means and simple to use method for facilitating the comparison of wines, distilled, brewed or other aromatic beverage, liquids or fine foods being tasted to aromas that may be present with little detraction from the elegance of the tasting experience. The method should be similar to the actual tasting experience and be conducted in a manner that can be easily shared by all participants in the tasting. Additionally, the apparatus to conduct the comparison of aromas should be as elegant as the wine or other aromatic beverage, liquid or fine food tasting itself. An apparatus that could be economically employed to enhance the wine tasting experience would be of benefit to the producers, sellers and consumers of millions of aromatic beverages consumed in United States each year.

### SUMMARY

It is an object of the present invention to provide an apparatus and method of presenting wine or other beverage related aromas for use in a tasting as an elegant and experience enhancing supplement. The contemplated aromatic beverages include wines, juices, distilled spirits, fermented beverages, brewed beverages, coffees, or teas. Alternatively, the tasting of olive and other oils, flavored naturally or by addition of ingredients after processing, is within the contemplated scope of this invention. Basically any type of drink, liquid or fine food where the tasting experience could be enhanced by presentation of a standard of aromas that would allow the discernment of flavors among the variety of flavors that may be present in the object of the tasting.

It is also an object of the present invention to provide aromas in groupings reflective of categories of wines, wine varietals such as a Cabernet Sauvignon or Merlot for example, or differences in scotch malt or malt preparation. In the case of coffees or teas, the aromas presented would be reflective of the growing regions or environments applicable to those products. In the case of olive and other distinctive oils, for example, the characteristics of the fruit maturity, climate of growth, soil and other environmental factors, imbue a different tasting experience that can be captured in aromas for use in the tasting. Alternatively, it is an object of this invention to provide aromas in groupings that are reflective of the environment in which, for example, the wine grapes are grown, such as the terroir or earthy aspects of the wine or oil, for example. Also, alternatively, it is an object of the present invention that the aromas can be grouped in manners or length of malt toasting or charcoal wood for filtering, in the case of malted beverages. In the case of brewed beverages, such as beer, coffee or tea, the toasting or other preparation techniques used to add distinctive flavors would be the types of aromas of interest to the methods and apparatus claimed here.

Still another object of the invention is to provide a method for using the aromas in a manner that simulates the actual tasting of the wine or other beverages. In this manner the person tasting the wine is presented with the essences in an environment that is similar to the wine being tasted.

Still yet another object of the invention is to provide an apparatus that is easy to use by the average beverage tasting consumer. The apparatus is easily portable and used with a minimal instruction to the user. The instructions for use can be provided on the apparatus, such that the apparatus itself is both useful and instructional.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1a represents an embodiment of the invention whereby a carrier material consisting preferably of a porous card stock or other inexpensively manufactured material is used to support encapsulated samples of aromatic scents useable in the exemplary wine tasting methods described herein.

FIG. 1b represents an embodiment of similar configuration as shown in FIG. 1a for other aromatic beverages, using a similarly configured carrier material impregnated with aromatic scents of appropriate selection.

FIG. 1c represents an embodiment of similar configuration as shown in FIG. 1a for hot brewed beverages.

FIG. 2 represents an embodiment of the most basic form of the invention using carrier material cards for the aromatic scents used in the beverage tasting methods described herein.

FIG. 3 represents an embodiment reflecting a more complex form of the carrier material cards with several of the aromatic scents used for the methods disclosed herein and also perforation separations and business logo information shown.

FIG. 4 represents an embodiment illustrative of how the FIG. 3 cards can be grouped into packs of cards for multiple use scenarios or for different groupings of the scents in the manner disclosed herein.

FIG. 5 represents an alternate embodiment illustrating a configuration showing groupings by wine varietal as an exemplary embodiment.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known items used to complete the process and method steps have not been described in detail in order not to unnecessarily obscure the present invention.

The present invention comprises an apparatus and method of use by which the tasting of wine or other aromatic beverages, oils, liquids or fine foods can be enhanced through the use of a complementary selection of aromatic scents selected specifically or generally for the beverage being consumed. The embodiments described herein are largely oriented to the consumption of wine or other fermented beverages, but as connoisseur of other beverages or foods where such methods enhance the experience would appreciate, the claimed invention is not limited to use for wine or the other exemplary beverages described herein. The order of presentation is exemplary in the embodiments presented and may be altered as necessary to provide a beverage tasting experienced desired by the user of the present invention. We are all consumers of beverages, each having our own preferences that are based from the basic concepts presented and claimed herein.

In a first exemplary embodiment, invention claimed herein is commonly available scratch and sniff cards which are appropriately selected from amongst commonly available scents. The selected one or more cards can be sampled by a sniff or inserted in some glass or chamber that allows the scents to build up and present themselves to the taster. The selection of the aromatic scents on the cards is based on the suggestive nature of the beverage being consumed. The suggestion of the scents is done by someone of discerning pallet for the beverage which could be the producer of the beverage or any other qualified taster. Additionally, the scents could be selected by consensus among a group and then when compared to the selected beverage, a greater appreciation for the constituent scents is achieved. As can be appreciated by anyone familiar with the tasting of beverages, oils, liquids or other fine foods, there are a great many varieties of tasting experiences where the sampling of an aroma can be done in a manner that enhances and, thus, the embodiments presented here are merely exemplary.

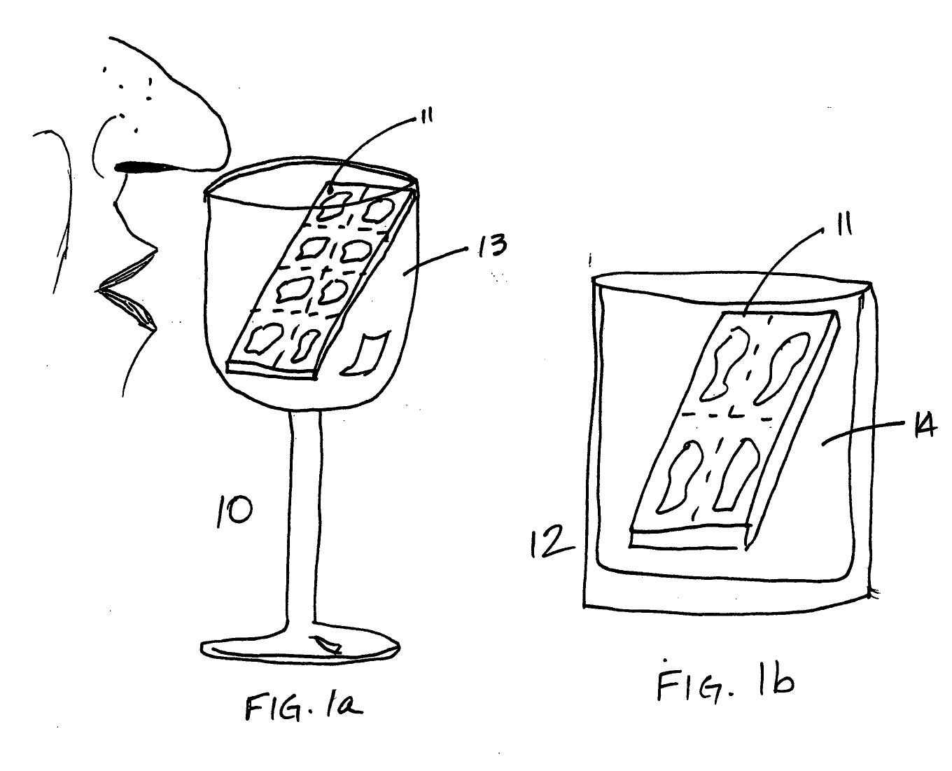

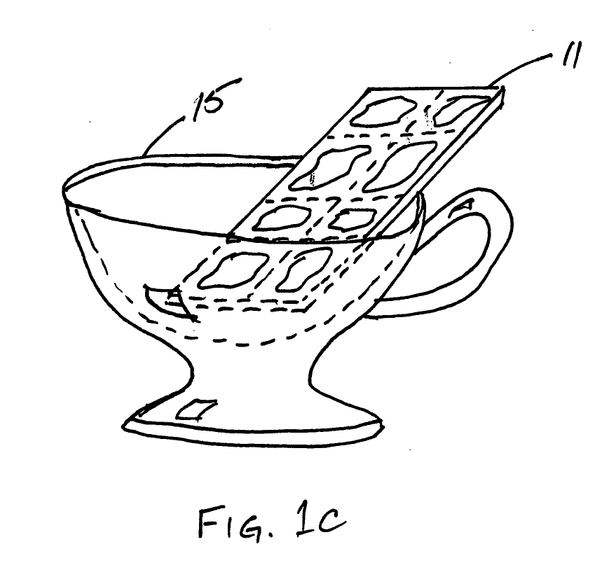

The embodiment shown in FIG. 1a illustrates the present invention being used to taste wine 10. One or more of the cards 11 comprising the carrier material with multiple scents thereon is selected an inserted by the taster into a glass 13 similar to that which will be used to taste the wine. Dissimilar glasses or other chambers may be used, but the experience is likely to be heightened by using similarly glasses of similar volume and shape. The consumer or taster's nose is then used in accordance with common practices of tasting to sample the chamber now full of the aromatic scent or mixed scents being emitted from the cards 11 in the glass 13. Thus a comparison of the selected scents to those present in the wine being tasted can be achieved. The taster then can achieve an appreciation of the subtle flavors of the wine or other aromatic liquid being tasted.

As it can be appreciated, the method described above can be repeated for additional tastings. The selection of the scents can be altered and either a different wine selected or the same wine selected with a different combination of one or more scents. Thus, the taster can narrow in on the right combination of the scents necessary for full appreciation of the subtleties of the wine being tasted.

FIG. 1b shows another preferred embodiment of the present invention being used to sample beverages other than wine 12. Scotch, rum or tequila, for example, are examples of distilled spirits that produce distinctive aromas and could benefit from use of the present invention. It can be appreciated by any connoisseur of similar beverage types that other spirits would benefit as well. Included in these additional beverages are brewed malt beverages, such as beer, malt liquor and hard cider, for example. The card carrier material 11 is inserted into a beverage glass 14 of a shape similar or dissimilar to that of the cocktail or other beverage being sampled. Similar to that shown in FIG. 1a, the taster samples the nose of the glass containing the card or cards selected and will get a sense of the scent or scents selected on the cards for use in the comparative tasting. The beverage consumer or taster then proceeds to get a similar sample of the nose of the actual beverage. Again, as with the wine, the comparison of the two results in an enhanced tasting experience and allows for the discernment of subtle flavors that may be present in the beverage.

FIG. 1c shows another preferred embodiment of the present invention being used to sample brewed beverages. Coffee, espresso, or teas, for example, are examples of brewed beverages that produce distinctive aromas and could benefit from use of the present invention. It can be appreciated by any connoisseur of similar beverage types that other hot beverages would benefit as well. Similar to that shown in FIG. 1a, the card carrier material 11 is inserted into a beverage glass 15 of a shape similar or dissimilar to that of the brewed or other beverage being sampled. The taster samples the nose of the glass containing the card or cards selected and will get a sense of the scent or scents selected on the cards for use in the comparative tasting. The beverage consumer or taster then proceeds to get a similar sample of the nose of the actual beverage. As with previous examples, the comparison of the two results in an enhanced tasting experience and allows for the discernment of subtle flavors that may be present in the beverage.

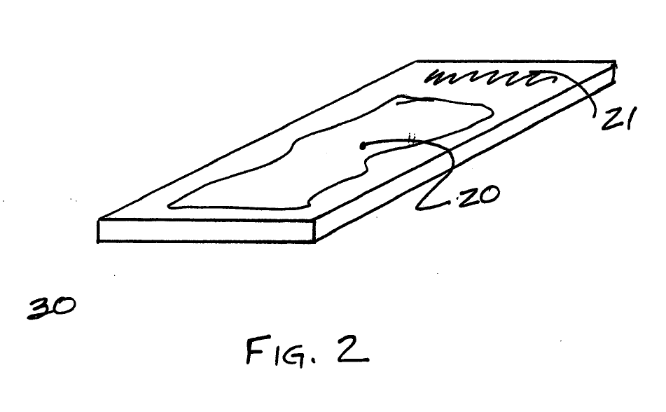

FIG. 2 illustrates an embodiment of the apparatus of the present invention, a card 30 consisting of a carrier material suitable to retain the means of producing the scent to be used 20. The area 20 is the active area of scent on the card. The active area can be encapsulated aromatic cells that are easily broken to produce the desired scent or other active component which has an attribute which when stressed or disturbed produces one or more scents suitable for the beverage tasting methods of the present invention. Additionally, an embodiment contemplates the use of hand warming or artificial heat sources to activate the area and cause the release of the aroma. It is an objective of the invention to ensure the taster has whatever means necessary to release the aroma in a way that emulates the food generated aromas to be sampled as part of the methods described herein.

Each active area 20 on the card can consist of a single scent or a mixture of scents specifically chosen to enhance the tasting experience of a selected beverage or group of beverages. Each grape variety has its own inherent flavors; Zinfandel often has aromas and flavors of peppery spice, berries and jam, Sauvignon Blanc often has aromas and flavors of grass, citrus and melon, Chardonnay often has aromas and flavors of butter, vanilla and apples, Cabernet Sauvignon often has aromas and flavors of berries, cocoa, and bell peppers, etc. If the beverage is a distilled, brewed or hot brewed beverage additional aromas appropriate to these beverage types are contemplated. When the embodiment appropriate to olive oils, other oils or other fine foods is used, yet a different selection of aromas of the other types described herein is appropriate.

As a matter of further example, the scents can be selected from fruits or aromatic spices present in the growing region of products used to create the beverage or oil, such as grapes for wine. The pollen from trees that may be native or non-native to the growing region a further example of the scents that may be used. As previously presented, the scents may be singularly present or present in mixtures on a single active area of the present invention. For each beverage, oil or other fine food being tasted, the aromas distinctive to that type of beverage would be selected for the samples provided on the active areas of the cards or carrier material used. In this sense, carrier material is broadly defined as any material that might hold the scent or aroma in a manner conducive to its use in the methods presented here.

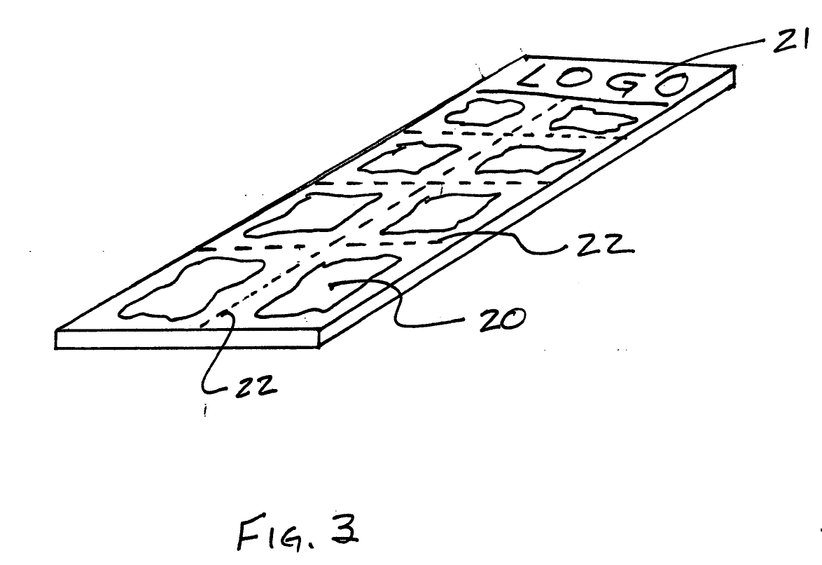

Because the present invention may be useful to promote specific products and can be mass produced in a manner that allows a producer to provide them with the product to be tasted, FIG. 3 shows an embodiment where the card 11 is combined with an area 21 reserved for a logo or other descriptive text. As with the simpler embodiments, the carrier material is arranged with active areas 20 to capture the aromatic scents to be used in the tasting.

The embodiment shown in the FIG. 3 illustration also shows where the active areas can be separated by lines of perforation or demarcation 22. These lines can be used to indicate to the taster which active area to be manipulated to produce the scent captured thereon or to enable separation of the card into one or more active areas in a group to be used in the methods of the present invention. The active areas can be individually selected or selected in groups to create a sub card arrangement suitable for use in the tasting method of the present invention. As it can be appreciated, the lines of demarcation or perforation could be bolded or colored in order to indicate groupings that the producer or other qualified taster indicated are the preferred groupings for selected wine varietals for instance. Alternatively, groupings reflective of malt toastings, coffee regions, or other things the taster would be prompted to consider together in the tasting would be assembled for presentation. As a further alternative, the scents could be arranged into groups with any one active area as a group of aromas selected to target a particular beverage, oil or other fine food. Thus, this invention builds on prior art which largely presents aromas in a singular fashion and contemplates mixtures of dominant, subtle and equal or unequal amounts to attempt to mirror the actual variety in nature and products being tasted using the apparatus and method of the present invention.

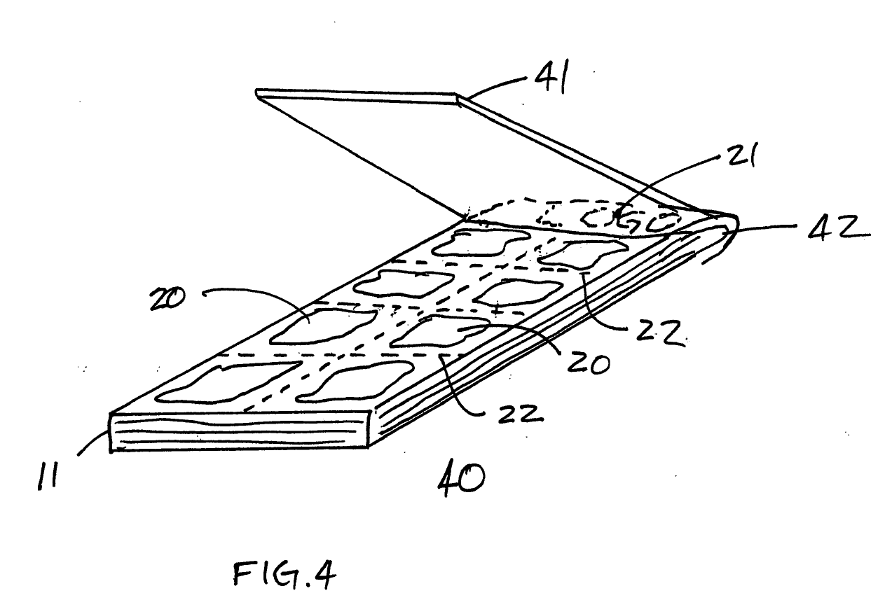

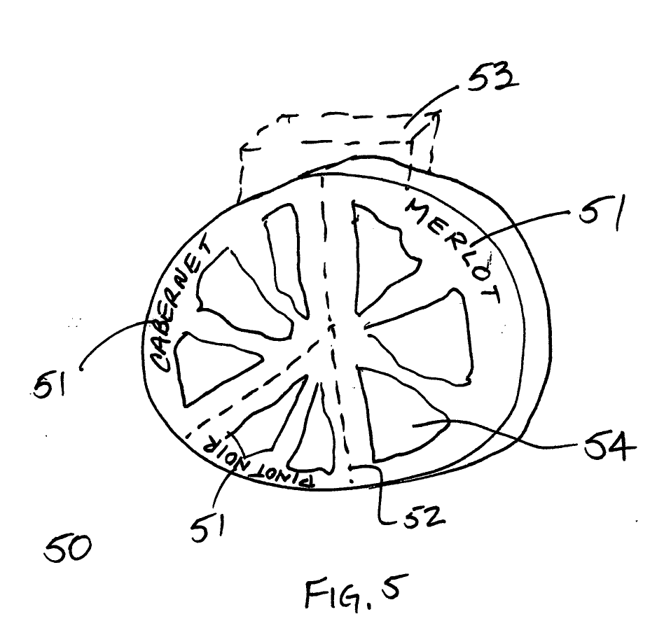

In an alternate embodiment, the cards may be arranged as shown in FIG. 4 where the pack of multiple cards 23 are bound on one end or side to form a book 40. The binding 42 can be performed by any commonly available method such as compression with adhesive or punching and post connection such as a staple. The illustration in FIG. 4 shows how each card 11 of the card pack may be turned up or opened one at a time as in the first card shown 41. As with previous embodiments, the active areas 20 are shown along with possible lines of demarcation or perforation 22. In this manner a selection of cards for different beverages or multiple tasting events can be arranged.

FIG. 4 also shows the arrangement of the previously described logo area suitable for the logo or other marking of the purveyor of the product to be tasted. Alternatively, this region may be reserved for instructions for the use of the present invention in the manner intended by those producing the bound cards for use.

FIG. 5 shows yet another preferred embodiment in a circular shape 50. The card is again divided into active areas 20 where an encapsulated material or other means for capture of the scents is provided. The lines of demarcation or perforation are also provided 52, except that since this is a circular arrangement, they are arranged radially about the center of the card. An area of the card 51 is reserved to label the grouping. The examples given here are different wine varietals, but as it can be appreciated these labels could be replaced with the names of spirits, soft drinks, other beverages or oils or fine foods being tasted. In that case the scents captured in the active areas, 51 under the label would be appropriate to the beverage for which the tasting enhancing card was produced.

The embodiment shown in FIG. 5 could also be used if the shape desired corresponded to the tasting wheels that are used in guiding tasters of the many products described herein. In such a case, the tasting wheel would have the active areas or active material integrated to give tasters either a single use or multiple use experience enhancement using the methods described herein. The tasting wheel that integrates the active areas as shown in FIG. 5 is only exemplary of the many types of arrangements that could occur to group aromas for use in the methods of this invention.

Even though a circular arrangement does not have one side for binding, FIG. 5 also shows a binding area 53 where an extension of each card could be made to facilitate the binding of the circular cards in a manner previously disclosed. Although separate figures showing circular cards with only one active area or circular cards with multiple active areas shown in a single card are not illustrated in the drawings, it should be appreciated that such embodiments were contemplated for the present invention.

Additionally, the preferred embodiments shown herein are shown on flat carrier material of a minimal thickness, essentially a sheet that is cut into some geometric shapes such as the rectangles or circles shown here, it should be appreciated that any geometric shape could be chosen and the same methods used. It is within the contemplation of the present invention that the shape could be anything that can be cut, shaped or molded from a suitable carrier material, such as a specific logo shape, as a matter of example.

Further embodiments of the present invention include the specific aromas associated with various coffees and teas. These scents could be placed on the outside of coffee bags and cans to allow the consumer to either experience the aroma of the product he or she is buying or other products produced by the seller. For instance, tea aromas could be placed on tea bag “tabs” and boxes so the consumer would not have to open products to experience them, but could sample the aroma and use the vent on the coffee bag for example, to compare to the active area integrated into the product packaging. They could also sample the scents offered in conjunction with a vendor's offering of samples designed to promote the product. Additionally, a company could use them in the development of training materials designed to assist employees with the development of their palate and skills to promote the products.

Additionally, active areas could be captured on a shape or surface of something arranged in a three dimensional way, such as a conical or cylindrical arrangement for example. Because it is believed that this method of providing scents may be a useful compliment to commercial promotion of beverage products, it is contemplated that such shapes conducive to presentation on or integrated with disposable beverage containers and other accessories to the beverage experience would fall in the scope of the present invention. Such embodiments could be detachable or integrated into the serving or packaging apparatus to be used by tasters to get a sense as to whether or not they could discern the flavor the retailer was promoting, either at the time of consumption either by sample at the store, sample during tasting at home or other locations or anticipating a future sale. That way the taster could get a sense of that which he or she might try on the next trip into the store and have a useful artifact for use in enjoying the product in the manner intended or imbued by the producer of the product.

Getting back to the wine tasting experience, it is commonly known that wines produced in the United States growing regions, of which there are many, will have many different aromas. The best wines will often consist of a complex selection. The aromas may not be fixed during the useful life of the wine, but even though they are changing, at any one moment they are discernable to the consumer or taster. A connoisseur of wine knows it should not be rushed. The partaking of the aroma of the wine is a multiple sample event by the taster involved in the selection and appreciation of a particular wine. Accordingly the sampling of the scents presented by the present invention should receive a similar lengthy process to appreciate the selected groupings.

As previously discussed, in the case of wine, scotch or other beverage with unique properties, the properties of the growing region of the constituent materials of the beverage can be imbued in the taste of the beverage. In some circles of beverage appreciation this is often referred to as the terroir of the wine or beverage. Some define it as the ominous earthy flavor of the wine. Still others characterize it as the total natural physical environment of a winegrowing area, usually as an indication of superiority.

Still others assert that the term terrior was coined by the French and is thusly defined be a French vintner in The Vintner's Art by Johnson and Halliday as: “Terroir looks at all of the natural conditions which influence the biology of the vinestock and thus the composition of the grape itself. It is the coming together of the climate, the soil and the landscape. It is the combination of an infinite number of factors: hours of sunlight, slope and drainage, rainfall distribution, etc.”

Assuming the producer of the wine can be satisfied be has created a scent simulating the desired terroir for his region, it is within present invention described herein that it be presented on one or more of the active areas on the carrier material or other chosen method of presentation of the aromas. This terroir can be presented alone or with some of the other flavors asserted to be present in the promoted wine, for example.

Additionally the scents can be designed to promote “earthy” flavors. The “earthy” flavors can be imparted to the wine from the soil and water conditions which may predominate a region. In these cases, the terroir is dominated by one or more flavors imbued in the wine and the producer of the cards of the present inventions need only provide the exemplary scents on the active areas of the card or cards. An additional wine aroma that could be provided is a sweet or bitter chocolatiness that is present in a more complex wine.

As previously described, in the case of a scotch the flavors being promoted will be more of a type of smoke or toasted peat or, in the case of a beer, the hops. Whatever the beverage, oil, or fine food being promoted some scents are also being promoted and the use of such scents in the manner described in the various embodiments provided herein are all within the contemplation of the present invention.

When it comes to scotch, the aromas and flavors are almost as limitless as those in hot brewed beverages. The types range from regional flavor to the attributes gained from filtration of the beverage. When it comes to regions there are flavors and aromas such as: Islay (strong, peaty flavors; iodine and charcoal extremely forward); Highlands (drier, malty flavor, subtle differences with hints of spice); Speyside (fruitier, more complex flavors); Lowlands (very subtle, almost pale flavors, very light). Just as with wine, aging and barrel types can change the scotch as well. Aroma differences that can be picked up in tasting range from flavor strength in the charcoal and peat, fruit, cherry overtones, and much more.

There are several specific desirable flavor characteristics of coffee and the types of coffee that are associated with those characteristics that can be appreciated using the techniques of many of the embodiments of the present invention. They are associated with the different coffee types and roasting techniques applied to each coffee. Just as in the case of other beverages that retain remnants of the region in which they are grown, coffee too can retain such properties that can be discerned using the method and apparatus disclosed here. Some of the many taste and aroma attributes that can be ascertained are: Caramel—candy like or syrupy, typical of Colombian Supremo; Chocolate—an aftertaste similar to unsweetened chocolate or vanilla, typically found in Costa Rican and Colombian Supremo; Earthy—a soily characteristic, typical of Sumatran; Fragrant—an aromatic characteristic ranging from floral to spicy, typical of Costa Rican, Sumatra Mandheling and Kenyan; Fruity—an aromatic characteristic reminiscent of berries or citrus; Mellow—a round, smooth taste, typically lacking acid, typical of Colombian, Sumatra Mandheling, Whole Latta Java and Organic Mexican; Nutty—an aftertaste similar to roasted nuts, typical of Colombian and Organic Mexican; Spicy—a flavor and aroma reminiscent of spices typical of Guatemala Huehuetenango; Syrupy—strong, and rich, typical of Sumatran; Sweet—free of harshness, typical of Colombian; Wildness—an unusual, gamey flavor, typical of Sumatran; and Winey—an aftertaste reminiscent of well-matured wine, typical of Kenyan, Guatemalan. While these examples seem comprehensive and complete, it can be appreciated that since the human palate can discern many aromas and tastes, the combination of tastes and coffee types and roastings create an almost limitless combination of things that can be appreciated using the techniques disclosed herein.

Teas can have many flavors that can be appreciated in the manner described herein. Black teas such as Assam (India) are described as full-bodied with a strong malty taste, and a clear, dark red brew. Ceylon (Sri Lanka) is characterized as very aromatic, golden-amber brew with a rich, full astringent flavor that is sometimes described as “fruity” or “biscuity.” Darjeeling (India) can be either light and astringent with an amazing aroma and a green muscatel, sometimes “flowery” taste, or a darker, more round, less astringent, and “fruitier” full-bodied flavor. Both provide varying degrees of muscatel and wood flavors, along with a rich, golden-red brew. Keemun (China) has a subtle orchid aroma and a rich, red brew. Lapsang Souchong (China) is a dark tea with a distinct smoky fragrance and flavor. Nilgiri (India) gives a bright and smooth, well-rounded, “fruity” mellow flavor. Yunnan (China) has a brisk, rich, slightly peppery or “spicy” taste with a pronounced floral aroma.

Other less common teas give completely different flavor and aroma experiences that can be used in the matter described here. Darjeeling (India) is an excellent oolong with a flavor finish of unripened fruit. Formosa (Taiwan) possesses a delicate, “fruity,” sometimes “nutty” taste and a superb aroma. It can be appreciated that there are a great many other teas and aromas that are included in the types of aromas contemplated for use in the context of the present invention.

Olive oil or other aromatic oil can be comparatively tasted, just as a good wine, single malt scotch. Just as in the case of a good wine, the quality and taste of the oil is influenced by geographical factors such as land or region. Additionally, depending on the weather during a certain season, there can be good and bad years for the olives or other fruit used to make the oil being tasted. The quality depends of the good care of growers and producers. For example, there are olive oils with a strong and with a mild taste, some are spicy and others have a grass taste or taste a bit like nuts. No olive oil is the same. Although the disclosure here refers to olive oil, the present invention contemplates any oil made from naturally occurring ingredients that is used in cooking, sampled alone or otherwise enjoyed in a tasting experience.

An additional embodiment includes the tasting of chocolate. People have compared chocolate tasting to that of tasting fine wine. There are subtleties of flavor and tones that you can train yourself to appreciate. The flavors and aromas to be appreciated are influenced by the origin of the beans and the roasting process. Much like wine experts, chocolate experts can find an incredible array of scents and aromas. Some chocolate flavors include: burnt bread, nutty, spicy, fruity and each of these has a corresponding aroma that will enhance the taster's experience and ability to discern the flavor.

The process of tasting chocolate or other firm foods may include some warming, either with the person's hand or artificial means as a method of enhancing the aroma release. Thus, the active areas present on the apparatus in one embodiment of the invention include areas which are actively released via the introduction of hand warming heat or other artificial heat sources. Thus, the experience of tasting of the sample and comparison to the aroma from the active areas of the apparatus can be made in similar manner.

The present invention is useful for tasting of other fine foods, such as bread, for example. For instance, when tasting bread, the taster can be in search of different ingredients, such as rye or wheat, in his or her tasting experience. Subtle tones can be introduced with the aromatic oils described here, as well as using nuts and fruits to enhance the experience to the consumer or taster. The present invention has utility to a person tasting such exemplary fine foods to discern the flavors introduced by the maker of the product. Although bread is discussed in this embodiment, it is well within the contemplation of this invention that any fine food, such as breads, cakes, cookies or other product could benefit from use of the present invention in tasting the products. Or perhaps, not traditionally characterized fine foods, such as chili cook-offs, barbeques, and other traditionally common foods which are now the subject of gourmet contests and tastings could benefit. Therefore, it can be easily seen that the invention is not limited to the embodiments and examples of food types, aromas or taste suggestions presented here.

The embodiments previously described are oriented towards wine or spirit tasting, hot beverages, oils or other aromatic fine foods. As such, the aromatic scents to be used on the active areas are suggested to be fruits, woods, spices and other scents common to those beverage types. In the case of spirits, additional features such as smoke or peatiness are also highly useful to the tasting experience. Notwithstanding these example embodiments, the present invention is not limited to the named scents. Any scent that can be captured in an active area and can be associated with a beverage to be tasted can be used. For instance it is not outside the chance that a sarsaparilla or vanilla scent could be used to enhance the experience of a soda fountain visit or a top shelf carbonated beverage being sold to consumers. Since the present invention is about enhancing an experience through the use of suggestive scents on inexpensive carrier material, any combination of scents can be used.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method of incorporating aromatic essences to enhance a tasting experience of an aromatic food product comprising:
providing at least one activatable aromatic essence in an active area on a carrier material, activating the aromatic essence,
sniffing the aromatic essence in sufficient quantity to enable a sense the aroma associated with the essence,
contemporaneously sniffing a food generated aroma, and
comparing the two samples to determine similarity.

2. The method in claim 1 where the carrier material is inserted into a sample chamber and the user sniffs the combined chamber and card as in the preparation for tasting the food product.

3. The method in claim 2 where the food product is a beverage and the activated aromatic essence is first place in a glass similar to that containing the beverage.

4. The method in claim 1 were the carrier material is a card.

5. The method in claim 1 where the carrier material is of a type which when stressed or heated releases the aroma.

6. The method in claim 1 where the aromatic essences are encapsulated and activated by scratching the active area.

7. The method in claim 4 where said card is a gridded card to enable separation into one or more subcards, with one or more of the active areas on at least one subcard.

8. The method in claim 3 where the aromatic essences correlate to a particular wine varietal or single malt scotch.

9. The method in claim 3 where the aromatic essences correlate to a hot brewed beverage such as coffee or tea.

10. The method in claim 2 where the chamber is a glass or cup.

11. The method in claim 1 where the food product is an aromatic oil or chocolate.

12. An apparatus for incorporating aromatic essences to enhance the tasting of an aromatic food tasting experience comprising:
a library of aromatic essences available to a beverage taster where said library comprises
a plurality of aromatic essences areas on at least a plurality of carrier materials;
wherein said library allows for the selection of one or more aromatic essences for use in a comparative tasting of foods.

13. The apparatus in claim 12 where the active aromatic essence area comprises an encapsulated aromatic essence.

14. The apparatus in claim 12 where the carrier material is card stock.

15. The apparatus in claim 12 where the active area is activated by application of stress or heat to the carrier material.

16. The apparatus in claim 12 where the carrier material is gridded to enable separation of the active areas in to sub units of the carrier material with one or more aromatic essences.

17. The apparatus in claim 12 where the library groups the aromatic essences by aroma characteristics on at least one card.

18. The apparatus in claim 12 where said scents are grouped by characteristic of the food product to be tasted.

19. The apparatus in claim 12 where the aromatic essences are characteristic of malted beers, single malt scotch, coffees, teas, or olive oils.

20. A method of incorporating aromatic essences to enhance the wine tasting experience comprising:
selecting a target varietal of wine,
selecting a carrier material with an area of activatable essence to be used in complement with the wine being tasted;
activating and inserting the essence into a wine glass,
sampling the essence by taking a sniff of the essence;
sampling the wine aroma by taking a sniff of the wine being tasted, and contemporaneously tasting the wine,
whereby the taster can compare the two sniffs and the taste to discern similar flavors present in the wine.
